(19) United States
(12) Patent Application Publication
(10) Pub. No.: US 2014/0069459 A1
(43) Pub. Date: Mar. 13, 2014

(54) METHODS AND APPARATUS FOR CLEANING DEPOSITION CHAMBERS

(71) Applicant: Novellus Systems, Inc., Fremont, CA (US)

(72) Inventors: Yan Guan, Cupertino, CA (US); Abhishek Manohar, San Jose, CA (US); Raashina Humayun, Los Altos, CA (US); Panya Wongsenakhum, San Francisco, CA (US)

(21) Appl. No.: 13/654,303

(22) Filed: Oct. 17, 2012

Related U.S. Application Data
(60) Provisional application No. 61/698,701, filed on Sep. 9, 2012.

(51) Int. Cl. H05H 1/24; B08B 9/00

(52) U.S. Cl. CPC H05H 1/24; B08B 9/00
USPC 134/1.1; 156/345.24

(57) ABSTRACT

Provided are methods and related apparatus for removing tungsten film from a station of a single-station or multi-station chamber and station component surfaces between tungsten deposition processes. In some embodiments, the methods can involve introducing an inert gas flow upstream of a gas inlet to a station and downstream of a remote plasma generator that provides activated cleaning species. In some embodiments, the methods can involve modulating inert gas flow during various stages of a cleaning process. In some embodiments, the methods can involve manipulating positions of a substrate carrier ring during various stages of the cleaning process. Also in some embodiments, the methods can involve differentially modulating the amounts of inert gas introduced to stations of a multi-station chamber. The methods can provide improved clean uniformity, reduced over-etch, and increased throughput due to shorter cleaning time.

### CROSS-REFERENCE TO RELATE APPLICATION

This application claims benefit under 35 USC §119(e) of U.S. Provisional Patent Application No. 61/698,701, filed Sep. 9, 2012, which is incorporated by reference herein.

### BACKGROUND

The deposition of tungsten films occurs at different stages of integrated circuit fabrication processes. For example, tungsten films can be used to form electrical connections such as vias between adjacent metal layers. Tungsten can be deposited by different processes, such as chemical vapor deposition (CVD) and physical vapor deposition (PVD) processes. As a result of such deposition, tungsten is deposited on exposed heated interior surfaces of the reaction station or chamber as well as on the partially fabricated integrated circuit. To maintain high throughput, low contamination, low particle, and fully functioning equipment after processing wafers in a deposition process, the accumulated tungsten film should be cleaned from station or chamber surfaces. Conventional cleaning techniques can result in excessive over-etch of certain chamber components. The result of excessive over-etch is lowered life expectancy of the chamber components and generation of contaminating particles that affect the integrated circuit fabrication process.

### SUMMARY

Provided are novel methods of removing tungsten film from a station of a single-station or multi-station chamber and station component surfaces between tungsten deposition processes. In some embodiments, the methods can involve introducing an inert gas flow upstream of a gas inlet to a station and downstream of a remote plasma generator that provides activated cleaning species. In some embodiments, the methods can involve modulating inert gas flow during various stages of a cleaning process. In some embodiments, the methods can involve manipulating positions of a substrate carrier ring during various stages of the cleaning process. Also in some embodiments, the methods can involve differentially modulating the amounts of inert gas introduced to stations of a multi-station chamber. According to various embodiments, the methods can include one or more of: introducing different amounts of inert gas to a first station relative to a second station, lifting the carrier ring in a station after the carrier ring is cleaned for a second stage cleaning process, using a high pressure stage prior to a low pressure stage where a second amount of fluorine in the second stage is greater than a first amount of fluorine in a first stage, indexing carrier rings prior to beginning the cleaning process, and indexing after a first stage of cleaning.

In one aspect, a method of removing film deposited on surfaces in stations of a multi-station deposition chamber is provided. Each station can be provided with a showerhead for introducing gas and plasma species to the station. The method includes introducing a first amount of an inert gas to a first station and a second amount of the inert gas to a second station; and introducing a first amount of fluorine from a remote plasma source to the stations in the multi-station deposition chamber via the showerheads.

The inert gas is introduced downstream of the remote plasma source and upstream of each showerhead, with the first amount of the inert gas being less than the second amount of the inert gas, and a substrate support temperature in the first station being higher than a substrate support temperature in the second station. In some embodiments, the film is a tungsten-containing film, such as tungsten. In certain embodiments, the inert gas is argon. According to various embodiments, the total amount of inert gas introduced to a station is not more than about 5000 sccm. In some embodiments, the total amount of deposited film in the first station is greater than the total amount of deposited film in the second station.

In some embodiments, the fluorine introduced is generated as atomic fluorine in the remote plasma source. According to these embodiments, generating the atomic fluorine in the remote plasma source includes flowing NF₃ into the remote plasma source.

According to various embodiments, the multi-station deposition chamber can have more than two stations, for example, four stations. In this embodiment, the method can further include introducing a third amount of the inert gas to a third station and a fourth amount of the inert gas to a fourth station. The amount of the inert gas introduced to a station with a higher substrate support temperature is lower than the amount of the inert gas introduced to a station with a lower substrate support temperature.

According to various embodiments, the method can further include lifting a carrier ring in a station; and introducing a second amount of fluorine from the remote plasma source to the station via a showerhead. The second amount of fluorine is greater than the first amount of fluorine. In some embodiments, the pressure of the chamber while introducing the first and second amounts of the inert gas and the first amount of fluorine is higher than the pressure of the chamber while introducing the second amount of fluorine.

Another aspect relates to a method of removing film deposited on surfaces in stations of a multi-station deposition chamber where each station of the multi-station chamber includes a showerhead and a substrate support. In some embodiments, the station includes a carrier ring.

The method includes a first stage at a higher pressure and a second stage at a lower pressure. The first stage includes introducing a first amount of an inert gas to a first station; and introducing a first amount of fluorine from the remote plasma source to the first station of the chamber. The inert gas is introduced downstream of the remote plasma source and upstream of the showerhead of the first station. The second stage includes introducing a second amount of fluorine from the remote plasma source to the first station of the chamber. In some embodiments, the second amount of fluorine is greater than the first amount of fluorine from the remote plasma source.

In some embodiments, the pressure during the first stage is about 10 Torr. In various embodiments, the pressure during the second stage is about 1 Torr.

According to various embodiments, the carrier ring is on the substrate support during the first stage and lifted from the substrate support during the second stage.

In various embodiments, the first stage further includes, prior to introducing the first amount of the inert gas to the first station, indexing the carrier rings between stations in the chamber, and the second stage further includes, prior to introducing the second amount of fluorine, indexing the carrier rings between stations in the chamber.

In some embodiments, indexing includes rotating a spindle configured to move carrier rings between stations in the chamber. In various embodiments, indexing moves at least two carrier rings and moves the carrier rings from one station to an adjacent station. Indexing typically moves all of the carrier rings of the apparatus together. In some embodiments, indexing moves four carrier rings. In some embodiments, carrier rings are indexed twice prior to introducing fluorine to the chamber.

In some embodiments of this method, the first stage further includes introducing a second amount of the inert gas to a second station. The inert gas is introduced downstream of the remote plasma source and upstream of the showerhead of the second station. According to various embodiments, the first amount of the inert gas is greater than the second amount of the inert gas and a substrate support temperature in the first station is greater than a substrate support in the second station.

Another aspect relates to an apparatus configured to remove film deposited on surfaces of a station after a deposition process. In some embodiments, the apparatus is a multi-station chamber including two or more stations, where each station includes a showerhead, substrate support; a remote plasma source; at least one indexing tool configured to move carrier rings between stations in the apparatus; and a controller for controlling the operations in the apparatus. The controller includes machine readable instructions for: executing a first stage at a first pressure, the first stage including: introducing a first amount of an inert gas to a first station and introducing a first amount of fluorine from a remote plasma source to the first station of the chamber; and executing a second stage at a second pressure less than the first pressure, the second stage including: introducing a second amount of fluorine greater than the first amount of fluorine to the chamber. The inert gas is introduced downstream of the remote plasma source and upstream of the showerhead of the first station.

In various embodiments, the controller further includes machine readable instructions for executing the first stage which further includes introducing a second amount of an inert gas to a second station. The controller includes machine readable instructions for introducing the inert gas downstream of the remote plasma source and upstream of the showerhead of the second station. In various embodiments, the controller includes machine readable instructions for introducing inert gas such that the first amount of the inert gas is greater than the second amount of the inert gas when a substrate support temperature in the first station is greater than a substrate support in the second station.

According to various embodiments, each station in the multi-station chamber further includes a carrier ring, and the controller further includes machine readable instructions for lifting the carrier ring from the substrate support during the second stage.

In some embodiments, the controller further includes machine readable instructions for, prior to introducing the first amount of the inert gas in the first stage, indexing carrier rings between stations in the chamber; and, prior to introducing the second amount of fluorine in the second stage, indexing carrier rings between stations in the chamber.

These and other aspects are described further below with reference to the drawings.

### BRIEF DESCRIPTION OF THE DRAWINGS

FIG. 1A shows a schematic illustration of a deposition station suitable for practicing various embodiments.

FIG. 1B shows a schematic illustration of a deposition station with tungsten film deposited on various surfaces of the station suitable for practicing according to various embodiments.

FIG. 2A shows a schematic illustration of a multi-station deposition chamber suitable for practicing various embodiments.

FIG. 2B shows a side view schematic illustration of parts of a multi-station deposition chamber and plasma generator for practicing various embodiments.

FIG. 3 is a process flow diagram showing relevant operations of methods of removing tungsten from stations according to various embodiments.

FIG. 4 is a process flow diagram showing relevant operations of cleaning tungsten in a station according to various embodiments.

FIG. 5 shows a schematic illustration of a multi-station deposition chamber and the relative positions of carrier rings suitable for practicing various embodiments.

FIG. 6 is a process flow diagram showing relevant operations of cleaning tungsten in stations of a multi-station deposition chamber according to various embodiments.

FIG. 8 shows a side view schematic illustration of parts of a multi-station deposition chamber and plasma generator for practicing various embodiments.

FIGS. 7, 9 and 10 show schematic illustrations of a tungsten deposition station during various stages of a cleaning process.

FIG. 11 is a schematic illustration of a station apparatus that may be used for practicing various embodiments.

FIGS. 12A and 12B are schematic illustrations of a multi-station apparatus that may be used for practicing various embodiments.

FIGS. 12C and 12D are schematic illustrations of a carrier ring and an indexing tool that may be used in a multi-station apparatus.

FIG. 13 is a side view schematic illustration of a multi-station apparatus that may be used for practicing various embodiments.

FIG. 14 shows etch rate of a chamber and a carrier ring in the station as a function of chamber pressure.

### DETAILED DESCRIPTION

In the following description, numerous specific details are set forth in order to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

Cleaning processes in deposition stations and chambers are important to maintaining the life expectancy of the equipment, decreasing operation cost, preventing particle contamination on wafer processing, and maintaining high throughput of wafers. Shorter clean times and more efficient cleaning methods are critical to various stages of processing wafers in integrated circuit fabrication.

In a multi-station chamber, cleaning time is limited to the station with the slowest cleaning process, particularly the station with the carrier ring with the slowest cleaning process. A fast cleaning process can cause peeling on a carrier ring and clean time difference between fastest and slowest cleaned parts can result in excessive over-etch of other parts of the station and components in other stations. Such over-etch results in particle contamination on wafers during wafer processing, reducing the quality of wafers and the life expectancy of the station and chamber equipment.

Conventional cleaning techniques typically involve using fluorine to clean the station and station components. Atomic fluorine is typically generated in a remote plasma generator and then introduced to the chamber at a pressure of less than 5 Torr. Pressure in conventional atomic fluorine based cleaning methods is generally as low as tolerable without damaging ceramic parts, such as the carrier ring. The exothermic reaction of fluorine and tungsten on the ceramic ring limits the cleaning rate and the maximum flow rate of fluorine that can be used—otherwise, breakage from thermal stress can occur. These operating conditions, however, result in large differences in etch rate across different stations and results in a longer cleaning time.

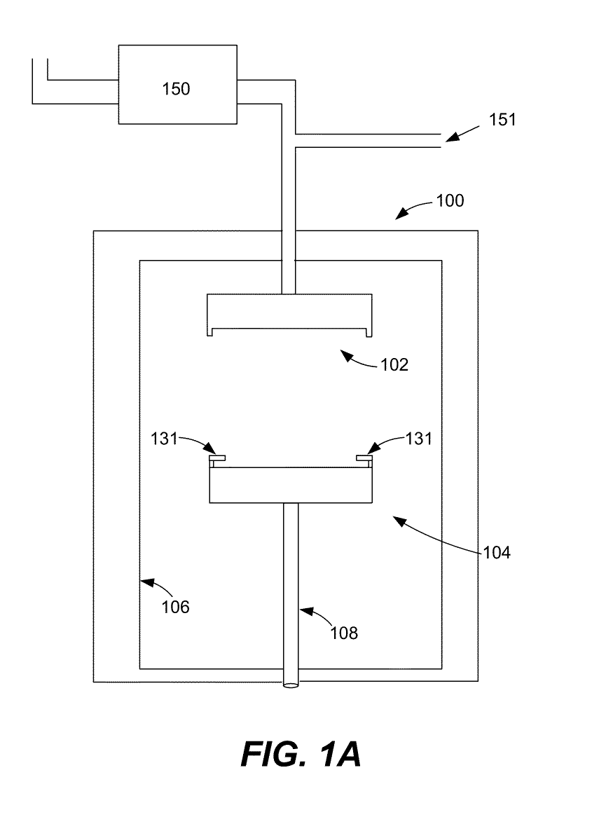

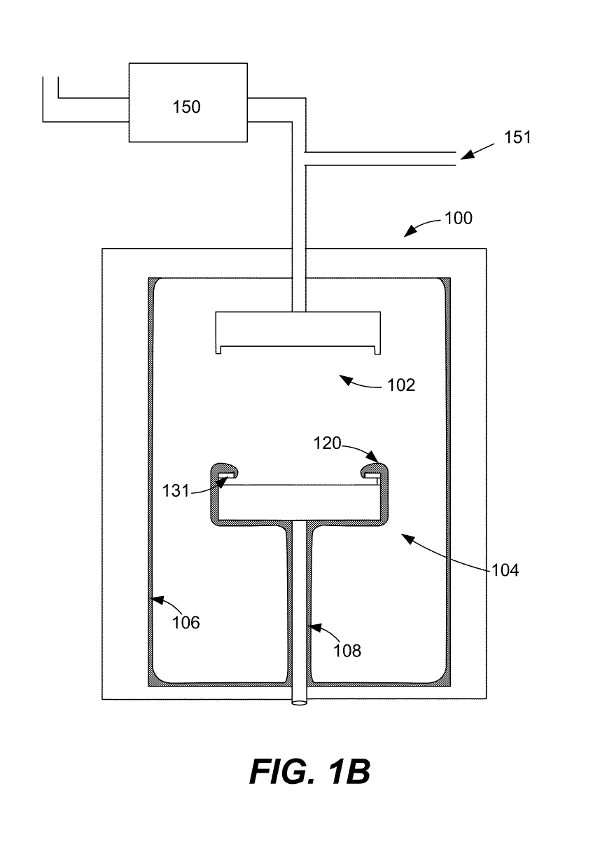

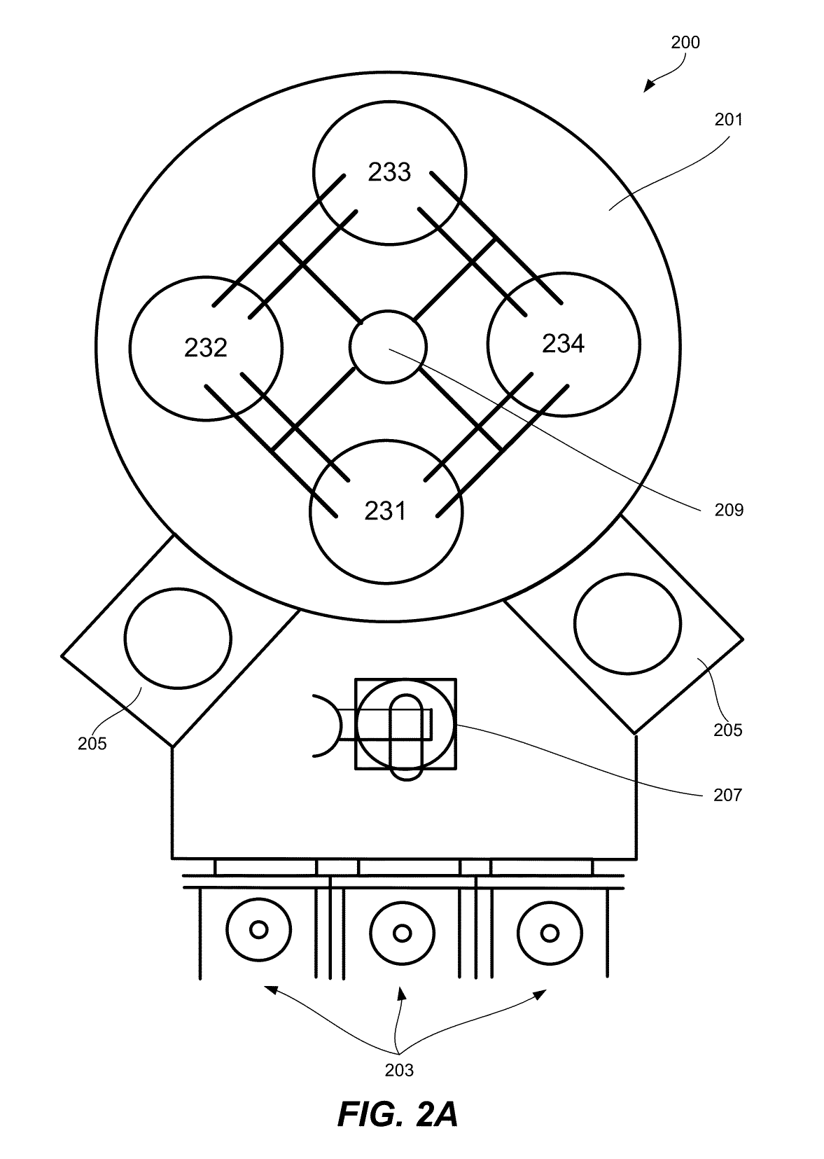

FIG. 1A shows a deposition station 100 with a substrate support 104, which is configured to support a semiconductor wafer or other substrate on which film is to be deposited. Examples of types of film include tungsten films and tungsten-containing films. The station 100 may be part of a multi-station or single station chamber and may have at least one substrate support 104. The substrate support 104 may be made of a material such as aluminum. Showerhead 102, or other gas inlet, is used to distribute reactant gases and/or plasma in the station 100 during deposition. Substrate support 104 supports the wafer during a deposition process. A carrier ring 131 on substrate support 104 may be used to position the wafer for deposition as a carrier ring and/or be placed over the wafer as an exclusion ring to prevent deposition on the edge of the wafer. The carrier ring 131 is typically made of ceramic material and can be lifted from the substrate support 104 towards the showerhead 102 as necessary. In the figure, carrier ring 131 is shown resting on pins but other configurations or arrangements may be employed.

The station 100 can also be connected to a remote plasma source such as the remote plasma generator 150. Remote plasma generator 150 generates plasma that is transferred via the inlets shown to the showerhead 102 and into the station 100. The station 100 can also be connected to inlet 151 for introducing carrier gases or other gases, such as reactant gases.

During a deposition process, e.g., a chemical vapor deposition (CVD) tungsten deposition process, reactant gases are introduced through showerhead 102. The reactant gases react to deposit a tungsten film on the wafer surface. For example, tungsten hexafluoride (WF₆) and a reducing agent such as H₂ are introduced to react and form tungsten. The deposited tungsten film may contain some impurities. In addition to being deposited on the wafer surface, however, tungsten film may form on any surface exposed to the reactant gases, including the interior surfaces 106 of the station 100, the underside of the substrate support 104, and support 108 of the substrate support 104 and on the carrier ring 131.

FIG. 1B shows a station after a wafer has been processed and transferred out following a tungsten deposition process. Tungsten film 120 is present on various station components, including the station wall surface 106, support 108 of the substrate support 104, surfaces of the substrate support 104, and the carrier ring 131. Unwanted tungsten deposition on station components is not limited to CVD processes, but also occurs during other types of deposition processes, including atomic layer depositions (ALD), pulsed nucleation layer (PNL) and physical vapor deposition (PVD) processes and the methods and apparatus described herein may be used to clean reactors configured for these types of processes.

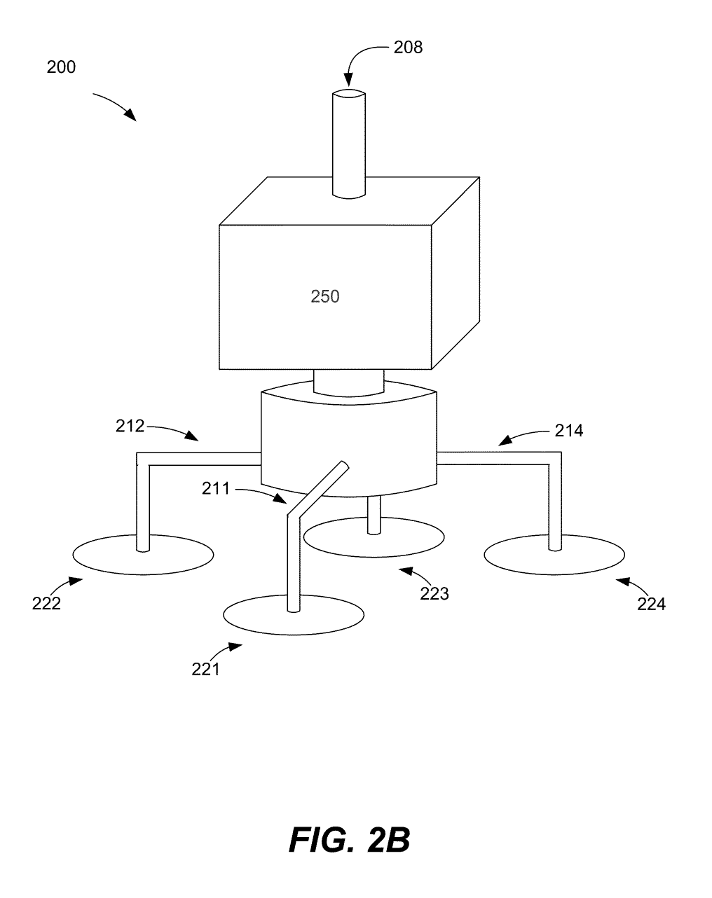

As noted above, optionally, a station can be one of many stations in a multi-station deposition chamber. FIG. 2A shows a multi-station chamber 200 with a processing chamber 201. Processing chamber 201 may have a number of stations—for example, two stations, three stations, four stations, five stations, six stations, or any other number of stations. The depiction in FIG. 2A shows a multi-station chamber with four stations (not shown) that correspond to each carrier ring 231, 232, 233, and 234. The number of stations is usually determined by the complexity of the processing operations. The chamber includes an indexing tool 209, such as a spindle, which moves the carrier rings 231, 232, 233, and 234 or wafers from one station to another station to hold wafers to be processed and wafers that have been processed. Load-locks 205 load the wafers to be processed from one of the cassettes 203 to the station corresponding to carrier ring 231. A robot 207 can be used to transfer the wafer from the cassette 203 and into the load-lock 205. Each station 231, 232, 233, and 234 may have independently controlled substrate support temperatures. In some embodiments, there may be one or more gas inlets (not shown) to the processing chamber 201 through which one or more flows of gas can be introduced throughout the processing chamber 201. In some embodiments, the wafers are loaded to the stations directly from a transfer chamber, which may be connected storage cassettes via load-locks. An example of a processing chamber where wafers are loaded directly from a transfer chamber is described below with reference to FIG. 12B.

FIG. 2B shows a schematic drawing of a portion of a multi-station chamber 200 from a side view, with a remote plasma generator 250, a fluorine distribution module 204, which distributes fluorine to showerheads 221, 222, 223, and 224 for each corresponding station (not shown) via the showerhead inlets 211, 212, and 214 (the showerhead inlet to showerhead 223 not shown) connected to the fluorine distribution module 204.

Embodiments of the disclosed embodiments involve methods of removing film from stations in single-station and multi-station chambers. Methods include modulating inert gas flow downstream of a remote plasma source, lifting the carrier ring after cleaning the ring to clean the rest of the station, indexing carrier rings, and executing a combination of these methods. The methods provide improved clean uniformity, reduced over-etch, and increased throughput due to shorter cleaning time.

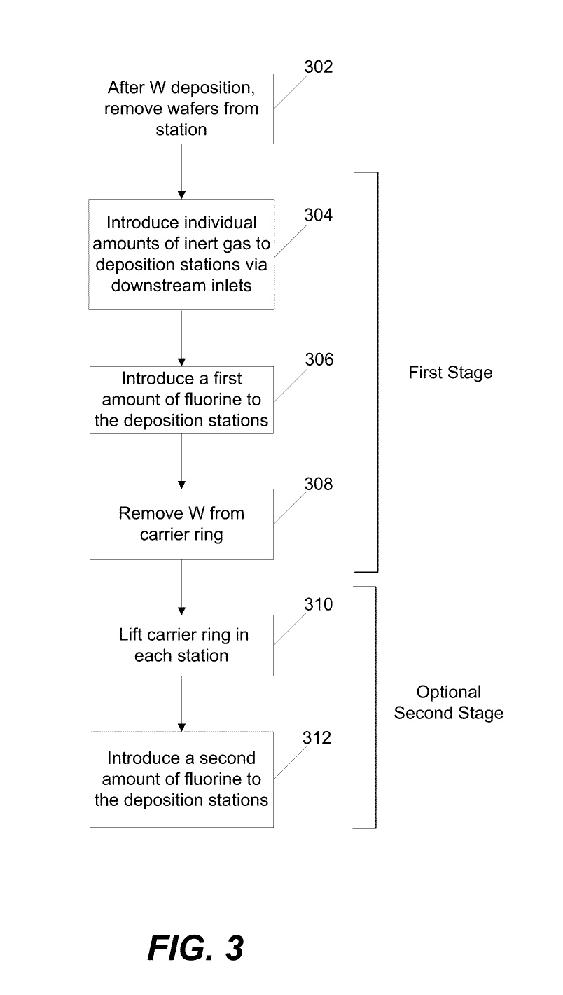

FIG. 3 is a process flow diagram showing operations in a method of removing tungsten from a tungsten deposition station according to certain embodiments. In some embodiments, this method of cleaning is performed on stations in a multi-station chamber with a remote plasma generator such as the ones described above with reference to FIGS. 2A and 2B. Initially in operation 302, the wafers are removed from the station after deposition of film. As mentioned, examples of films include tungsten-containing films and tungsten films.

In some embodiments, operations 304-308, described below, represent a first stage in which carrier rings are cleaned. Next, in operation 304, amounts of inert gas are introduced individually to each station. According to various embodiments, the amounts of gas directed to each station be the same or different. According to various embodiments, the relative amounts of gas directed to each station can be based on relative substrate support temperatures of each station and/or relative amounts of tungsten deposited in each station. Differences between temperatures of the substrate support between the stations will depend on the particular deposition process and may vary up to about 150° C. in some embodiments. For example, temperatures of the substrate support of each station can range from about 300° C. or lower to at about 450° C. or higher. These ranges may be different depending on the particular process. In some embodiments, the temperature of the substrate support of a station is about 300° C. In some embodiments, the temperature of the substrate support of a station is about 400° C. In some embodiments, the temperature of the substrate support of a station is about 430° C. The amount of inert gas introduced can also depend on the amount of film in the station.

While higher temperature processes may result in the thickness of a tungsten film being greater on chamber walls and other chamber components, the amount deposited on each carrier ring may be about the same. A higher temperature chamber will provide an increased reaction rate. Accordingly in certain embodiments, more inert gas may be introduced to higher temperature stations to balance clean rates. However, in some embodiments, balancing clean rates can be achieved by flowing approximately the same amount of inert gas to each station from the showerhead. This is because inert gas flow to each individual station from the showerhead can result in competing effects on clean rate: a higher flow rate tends to give more momentum for the NF₃ or other etchant species to travel from center to edge, contributing to a higher clean rate. In some embodiments, higher flow rate dilutes the etchant species, contributing to a lower clean rate. In some cases, these two effects can balance out allowing a balanced clean rate to be achieved by flowing the same amount of gas to each station from the showerhead. Further, in some embodiments, modulated argon flow from individual pedestals is provided to help balance clean rates. Flow from a pedestal has the effect of diluting gas and slowing clean rates. For example, argon can be flowed from a pedestal edge to help to slow down ring clean rate on higher temperature pedestals.

Examples of an inert gas to be used in this operation include argon and nitrogen. In some embodiments, the amount of inert gas introduced to a station with a higher substrate support temperature is less than the amount of inert gas introduced to a station with a lower substrate support temperature. In some embodiments, inert gas may be introduced at a flow rate of about 0 sccm to about 4000 sccm to each station, for example, from about 0 sccm to about 1500 sccm to each station. In some embodiments, the total amount of inert gas introduced to all stations may be between about 0 sccm to about 12000 sccm of inert gas.

In some embodiments, inert gas is introduced to each station downstream of the remote plasma source and upstream of the station showerhead. In some embodiments, an amount of gas is introduced so that it help to carry clean species flow to the rings that sit on the edge of a support substrate at a particular station as described above.

Operation 304 can be modified as necessary to accommodate the stations in a multi-station chamber with a number of stations. Multi-station chambers can have at least two stations, or at least three stations, or at least four stations, or at least five stations, or at least six stations, or more. In some embodiments, the multi-station chamber has four stations. For example, operation 304 can be modified such that different amounts of inert gas are introduced to each of the four stations. In some embodiments, the amount of inert gas introduced to any one station with a greater substrate support temperature relative to another station is less than the amount of inert gas introduced to the another station with a lower substrate support temperature.

FIG. 2B as previously discussed shows a multi-station deposition chamber including a remote plasma generator 250, and four showerhead inlets to transfer the fluorine from the fluorine distribution module 204 to the showerheads 221, 222, 223, and 224, with each showerhead part of an individual station to a station. Inert gas can be introduced directly to the showerhead inlets 211, 212, and 214 according to various embodiments, via one or more inlets (not shown) to showerhead inlets 211, 212, and 214. In this manner, the amount of inert gas can be modulated differently amongst each station.

Referring back to FIG. 3, in operation 306, a first amount fluorine is introduced to the deposition stations from a remote plasma source via the showerheads of each station. In some embodiments, the fluorine is generated as atomic fluorine in the remote plasma generator. In various embodiments, a fluorine-containing gas, e.g., nitrogen trifluoride (NF₃), is flowed into the remote plasma generator in order to generate atomic fluorine. According to various embodiments, the species entering the fluorine distribution module 204 and stations may include recombined molecular species such as NF₃ or F₂ as well as atomic species.

As shown in FIG. 2B, NF₃ can be introduced to the remote plasma generator 250 at 208, and plasma generated flows to the fluorine distribution module 204. A greater amount of inert gas up to a threshold amount redirects fluorine from the fluorine distribution module 204 to other stations. The flow rate of NF₃ or other fluorine-containing gas to the remote plasma generator may be at least about 3750 sccm or at least about 4000 sccm or at least about 6500 sccm. In some embodiments, the flow rate of NF₃ is about 6500 sccm.

In some embodiments, chamber pressure can be varied during the cleaning process to modulate the cleaning species present in the chamber. Varying pressure during cleaning is described, for example, in U.S. Pat. No. 8,262,800, incorporated by reference herein. In some embodiments, by appropriately adjusting the pressure, a showerhead can act as a tunable source of the atomic and/or molecular fluorine etchant. For example, in some embodiments at high enough pressures, e.g., greater than about 8 Torr, or in certain embodiments, greater than about 5 Torr, the fluorine atoms recombine in the showerhead and inlet tube and/or near the surface of the showerhead outlet and create molecular fluorine. At lower clean pressures, e.g., less than 5 Torr, or less than about 3 Torr, atomic fluorine generated does not recombine at a fast rate. In some cases, molecular fluorine may be used to clean a side and/or underside of the pedestal with atomic fluorine is available to clean the top of the pedestals and the rings. (One of skill in the art will understand that other species may be present in the plasma or gases exiting the showerhead into the reactor. For example, during a low pressure stage, the species entering the deposition chamber from the showerhead typically include NF₃ and NFₓ as well as atomic fluorine. In some embodiments, no ions or electrons are present in significant amounts. At the high pressure stage, NF₃ as well as F₂ may be present.)

Next, in operation 308, film is removed from the carrier ring and the station. In certain embodiments, the tungsten is removed from the surface and inner diameter of the carrier ring. In some embodiments, the chamber pressure in operations 302 to 308 is about 8 Torr to about 15 Torr. In some embodiments, the chamber pressure in operations 302 to 308 is at least about 8 Torr, or at least about 10 Torr. The relatively high pressure can result in cleaning carrier rings smoothly at moderate speed. Lower pressure ranges may also be used as appropriate.

In some embodiments, an optional second stage may take place. The second stage can include operation 310, in which after the carrier ring is cleaned, the carrier ring is lifted from the substrate support. The mechanism and apparatus for this process is further described below with reference to FIG. 12.

In operation 312, a second amount of fluorine can be introduced to the deposition stations. In some embodiments, the second amount is higher than the first amount introduced in operation 304, for example between about 20% and 70% higher. The higher flow rate can allow a faster etch rate. In some embodiments, NF₃ can be flowed into the remote plasma source to generate more fluorine to clean the rest of the station in operation 314. In some embodiments, the flow rate of NF₃ or other fluorine-containing gas to the remote plasma generator is between about 6000 sccm and about 10000 sccm. In various embodiments, the flow rate of the fluorine-containing gas to the remote plasma generator is about 8000 sccm. In some embodiments, this operation is executed over a shorter period of time than operation 306; for example operation 312 can be up 20% shorter than operation 306.

In some embodiments, the second stage is performed at lower chamber pressures than the first stage. For example, in some embodiments, the pressure in operations 310 to 314 is about 1 Torr to about 8 Torr, or below or equal to about 5 Torr, or below or equal to about 3 Torr. In various embodiments, the pressure in operations 310 to 314 is less than the pressure in operations 302 to 308. The lower pressure can provide a faster etch rate of the tungsten film in the chamber after the carrier rings are cleaned in the first stage.

According to various embodiments, the second stage may not involve introducing inert gas to each station individually, though inert gas may be flowed to the chamber as a whole. In some other embodiments, inert gas may be introduced to individual stations during the second stage. In some embodiments, the amount of inert gas introduced to a station with a greater amount of film can be less than the amount of inert gas introduced to another station with a lesser amount of film. Examples of accumulations of film in stations can range from about 0 μm to about 30 μm in film thickness. Film thickness can vary according to the particular process or processes performed in each station; for example, a film less than 5 μm thick may accumulate in one station with another station having a film thickness up to about 30 μm, such as between 25 lam and 30 μm. In some embodiments, the amount of inert gas introduced to a station with a higher temperature can be less than the amount of inert gas introduced to another station with a lower temperature. The inert gas dilutes the etchant, resulting in a lower clean rate. Thus, total clean time can be balanced between stations having varying amounts of tungsten.

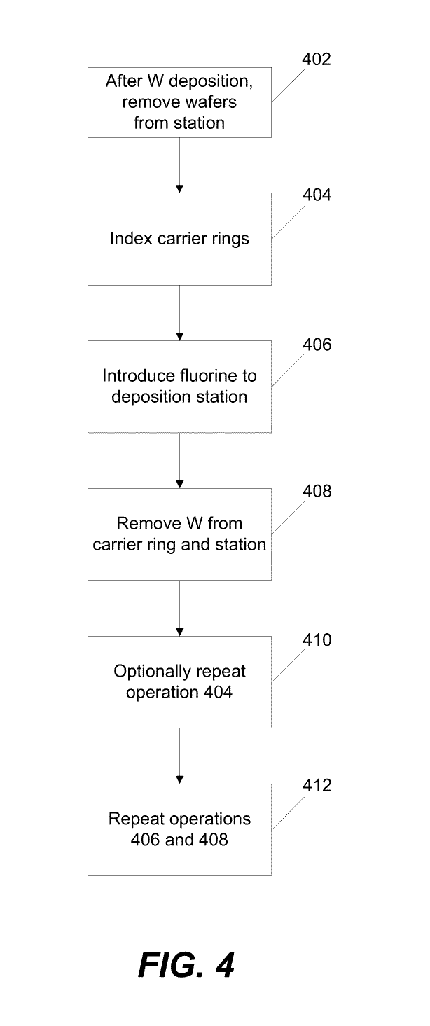

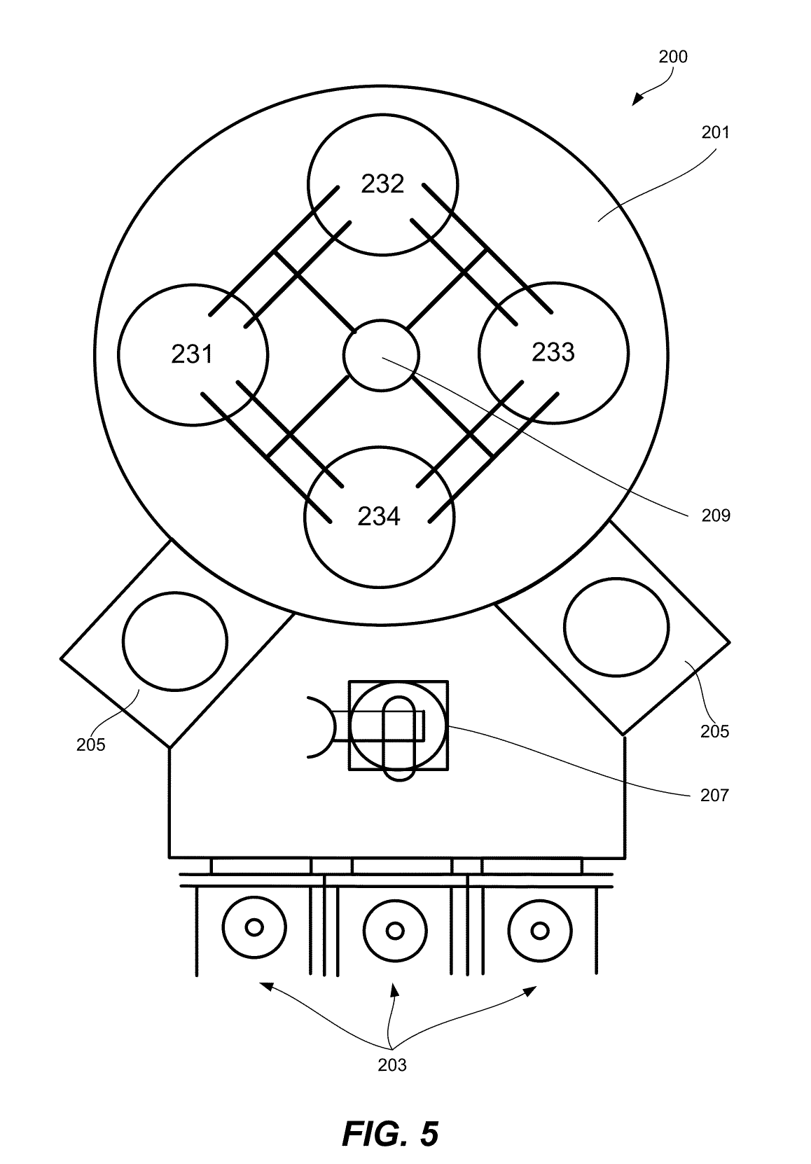

FIG. 4 shows a process flow diagram according to some embodiments. First, in operation 402, wafers are removed from the station after tungsten deposition on the wafer. This is similar to operation 302 of FIG. 3.

Next, in operation 404, carrier rings are indexed such that carrier rings move from one station to a different station in a multi-station deposition chamber. Indexing can be performed using any indexing tool. For example, a spindle can be used to index, where the spindle is rotated to move carrier rings from station to station. In various embodiments, indexing can be performed to move carrier rings from station-to-station, with the number of carrier rings determined by the number of stations. In a certain embodiment, indexing is performed using a spindle on four carrier rings. In some embodiments, carrier rings are indexed from a station with a higher substrate support temperature to a station with a lower substrate support temperature. In some embodiments, carrier rings are indexed to move carrier rings from a station with a lower substrate support temperature to a higher substrate support temperature.

An example of indexing is shown in the figures. FIG. 2A shows a multi-station chamber before indexing, such as in operation 502. FIG. 5 shows the multi-station chamber when indexing has occurred, where carrier rings 231, 232, 233, and 234 have been shifted clockwise to an adjacent station by rotating a spindle 209. Indexing can move carrier rings to an adjacent station, or a station not adjacent to the original station.

Indexing can be performed after deposition is completed and wafers are removed, and before cleaning the station. In some embodiments, indexing can be performed after the carrier ring is cleaned and before other parts of the station are cleaned. In other embodiments, indexing can be performed at a different time during the cleaning process. In some embodiments, indexing is performed in any combination of these times. Indexing can be performed at least once, or at least twice, or at least three times or more. In some embodiments, indexing is performed twice during the cleaning process. In some embodiments, indexing is performed twice after wafers are removed and before stations are cleaned. In some embodiments, indexing is performed twice after the carrier ring is cleaned. In certain embodiments, indexing is performed twice such that a carrier ring 231 from FIG. 2A is moved from the station corresponding to carrier ring 231 to the station corresponding to carrier ring 233. In certain embodiments, indexing is performed twice first before cleaning begins and twice again after the carrier ring is cleaned but before the rest of the station is cleaned. In some embodiments, indexing is not performed during the cleaning process.

According to various embodiments, indexing can balance the temperature between the carrier ring, the substrate support, and the station. For instance, when a carrier ring from a station with a higher substrate support temperature moves to a station with a lower substrate support temperature, the temperature in the latter station is balanced. When temperature is balanced, the cleaning time is not limited to the station with the highest temperature or the station with the slowest cleaning, and therefore over-etch is prevented on all stations. Indexing also cools the carrier ring during the process of transferring the carrier ring from one station to another station which also helps in balancing the temperature in each station.

As discussed above, according to various embodiments, temperatures of the substrate support between stations may vary up to about 150° C., with temperatures of the substrate support of each station can range from at least about 300° C. to at least about 450° C. In some embodiments, the pressure can be between about 1 Torr and about 10 Torr or more.

Next, in operation 406, fluorine is introduced to the deposition station. According to various embodiments, this operation can be similar to that of operations 306 and 312 in FIG. 3. The same limitations and conditions with reference to FIG. 3 above can be applied, including flow rate of fluorine.

Next, in operation 408, tungsten is removed from the carrier ring and the stations. In some embodiments, tungsten is removed from the carrier ring and the inner diameter of the carrier ring. In operation 410, indexing can be performed again by repeating operation 404. Then operations 406 and 408 can be repeated in operation 412 as necessary to clean the station until the tungsten film is cleaned from all or almost all surfaces of the station. Operations 410 and 412 can be repeated until all or almost all surfaces of the station are cleaned.

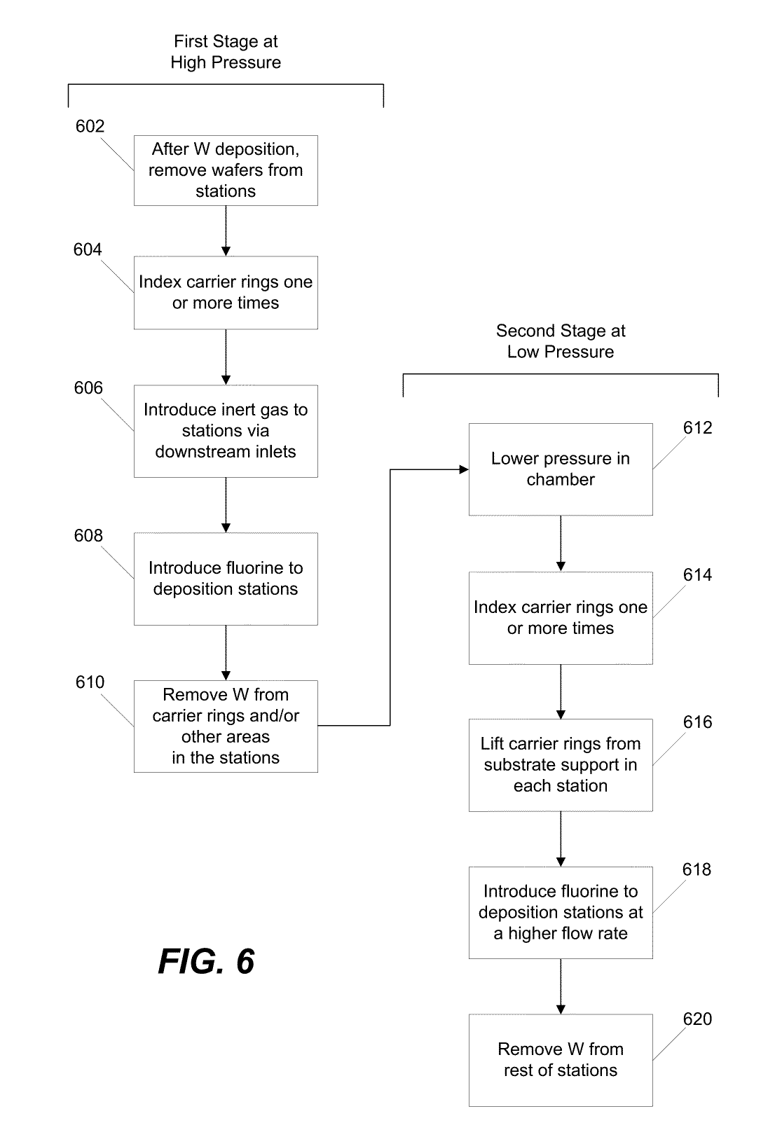

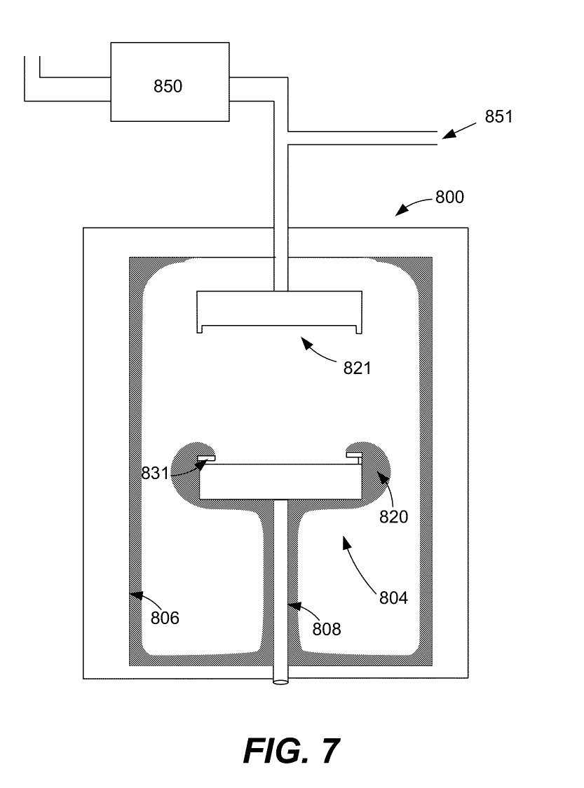

FIG. 6 shows a process flow diagram according to certain embodiments. First, in operation 602, wafers are removed from stations of a multi-station deposition chamber after tungsten deposition. One example of a station is depicted in FIG. 7, which shows a station after the wafer is removed from the station. The station is connected to a remote plasma generator 750 by inlet 751 and has a showerhead 721 and substrate support 704 and support 708 of the substrate support. On top of the substrate support is a carrier ring 731. As shown in the figure, tungsten film 720 was deposited on the station walls 706 as well as on the substrate support 704 and under the substrate support during the deposition process.

Referring to FIG. 6, in the first stage operated at a high pressure, in operation 604, carrier rings are indexed one or more times. In some embodiments, the chamber pressure is at least about 8 Torr. In some embodiments, the pressure of the chamber is about 10 Torr. In various embodiments, the pressure of the chamber is constant during the first stage.

The carrier rings can be indexed such that a carrier ring in a first station is moved to a station having a different substrate support temperature than the first station. For example, the first two stations of a four station chamber can be pulsed nucleation layer (PNL) stations for depositing tungsten nucleation layers and the third and fourth stations can be chemical vapor deposition stations (CVD) stations for depositing bulk tungsten films, with the first and second stations having the same or similar substrate support temperatures and the third and fourth station having the same or similar substrate support temperatures. Indexing the carrier rings twice moves a carrier ring from a PNL station to a CVD station and moves a carrier ring from a CVD station to a PNL station.

Variations of indexing are similar to those discussed with reference to operation 404 of FIG. 4. In some embodiments, indexing carrier rings moves carrier rings from a station with a higher substrate support temperature to a station with a lower substrate support temperature. In some embodiments, indexing carrier rings moves carrier rings from a station with a lower substrate support temperature to a station with a higher substrate support temperature.

Next, in operation 606, inert gas is introduced to inlets connecting to each station downstream of the remote plasma generator and upstream of the showerheads of each station. This is similar to operation 306 discussed above with reference to FIG. 3. In various embodiments, the inert gas used to flow into the stations is argon.

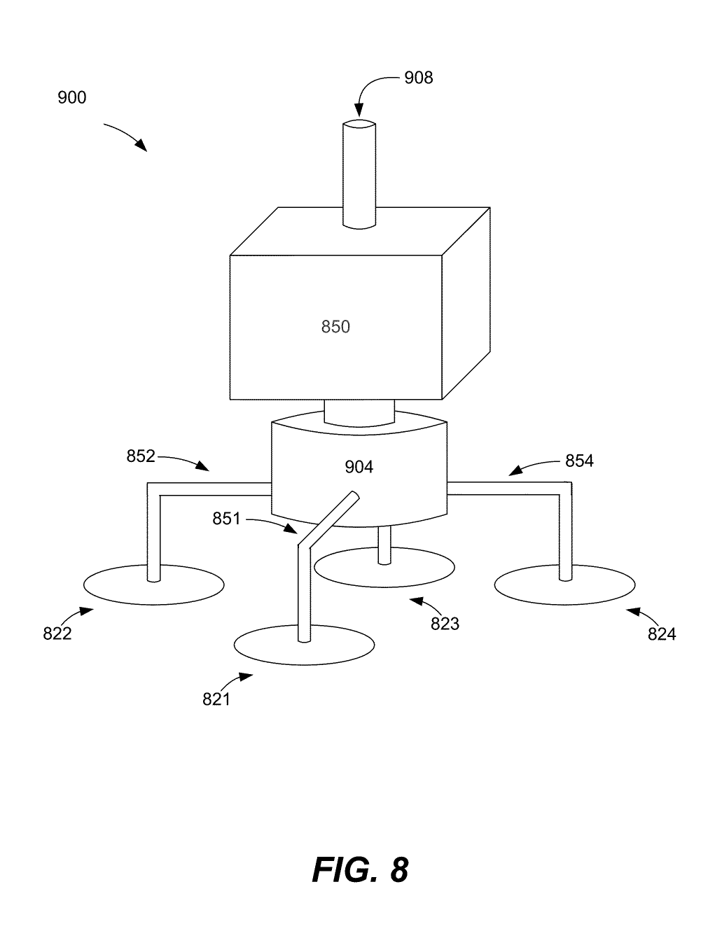

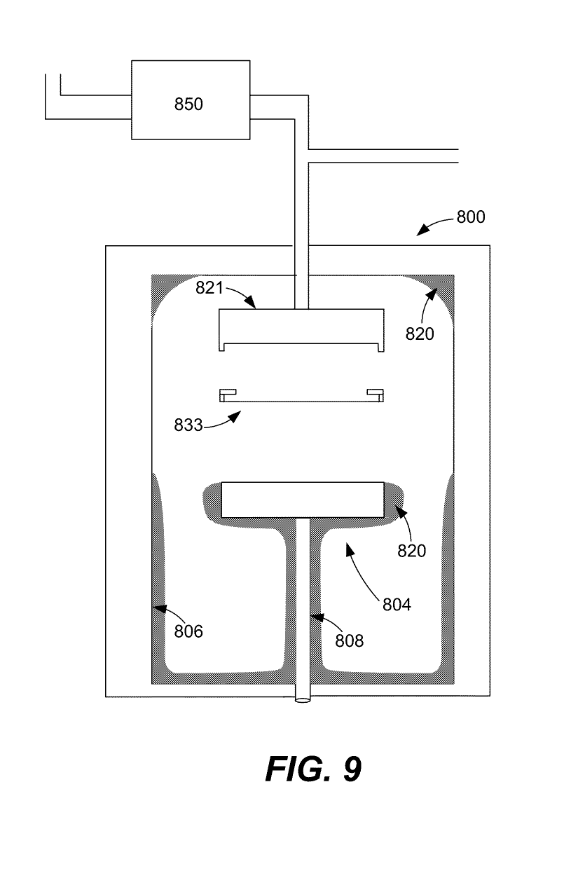

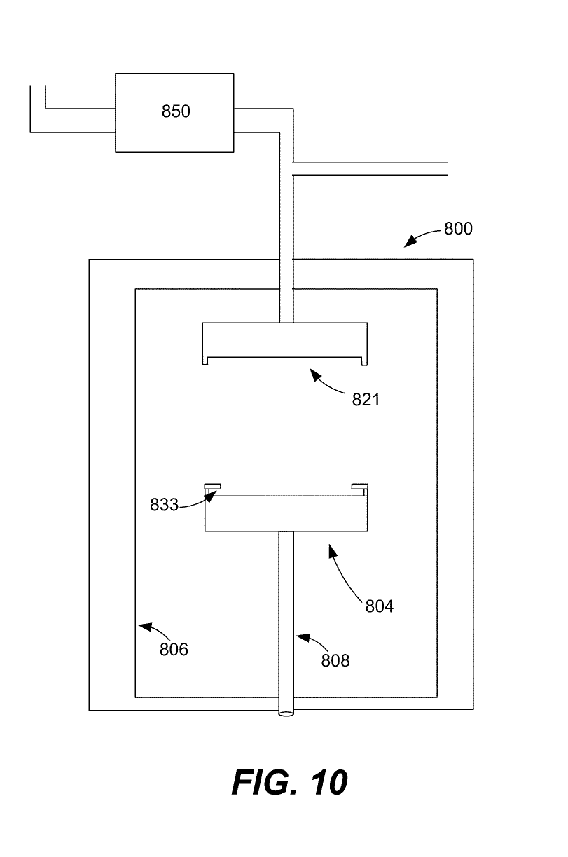

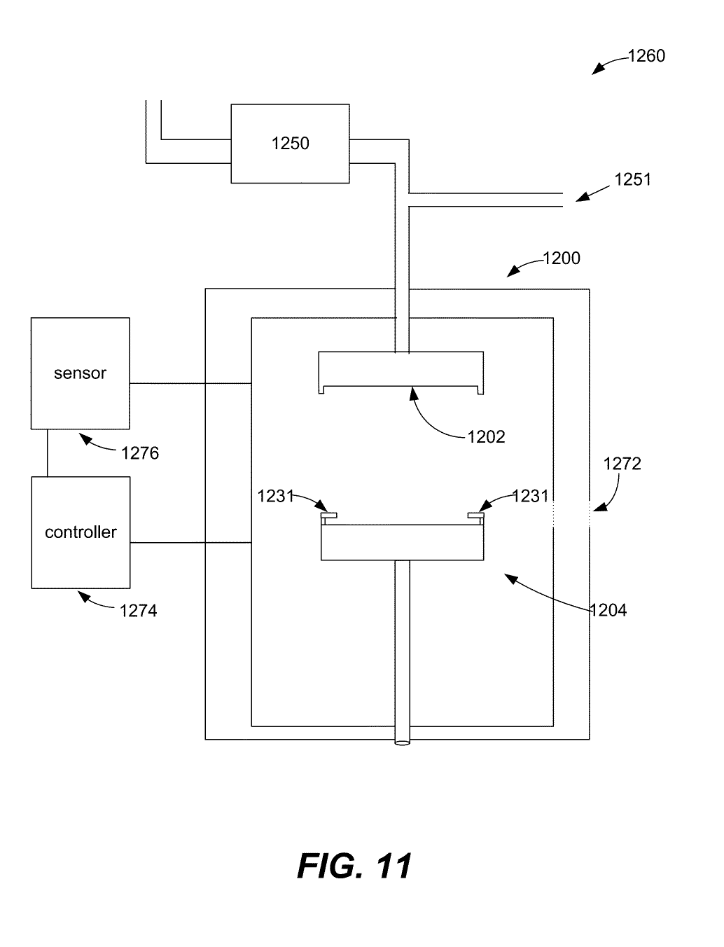

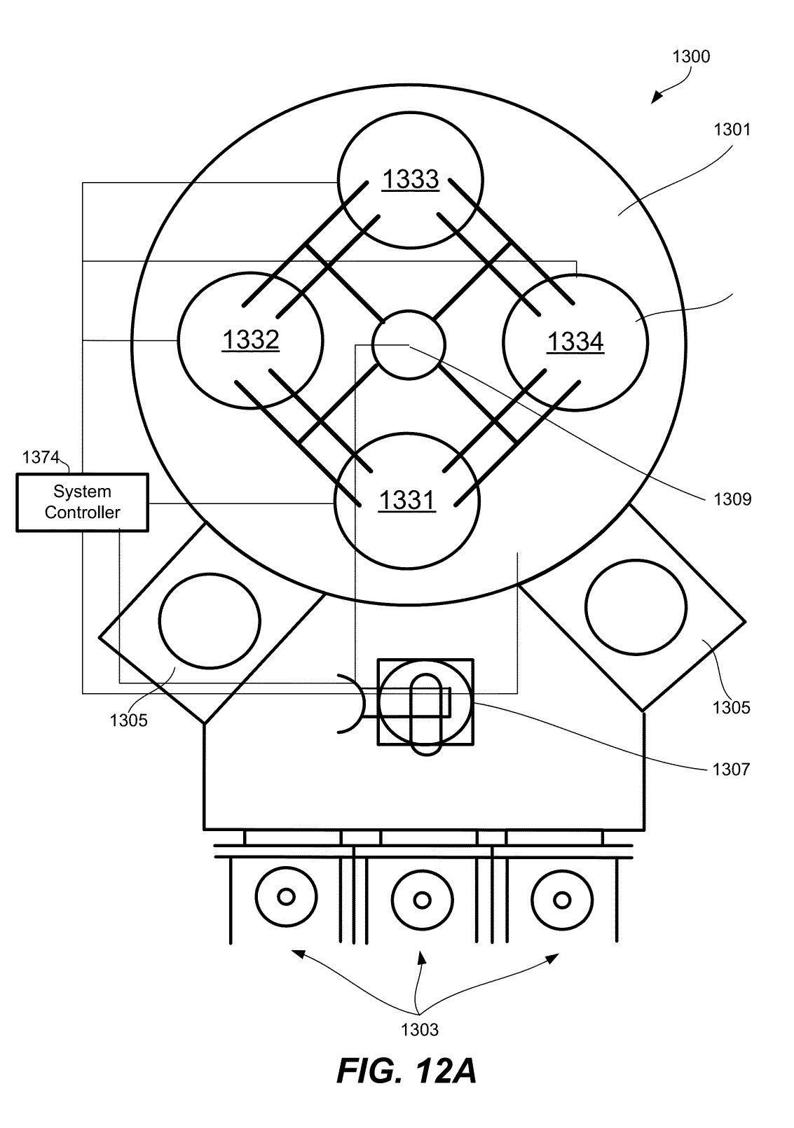

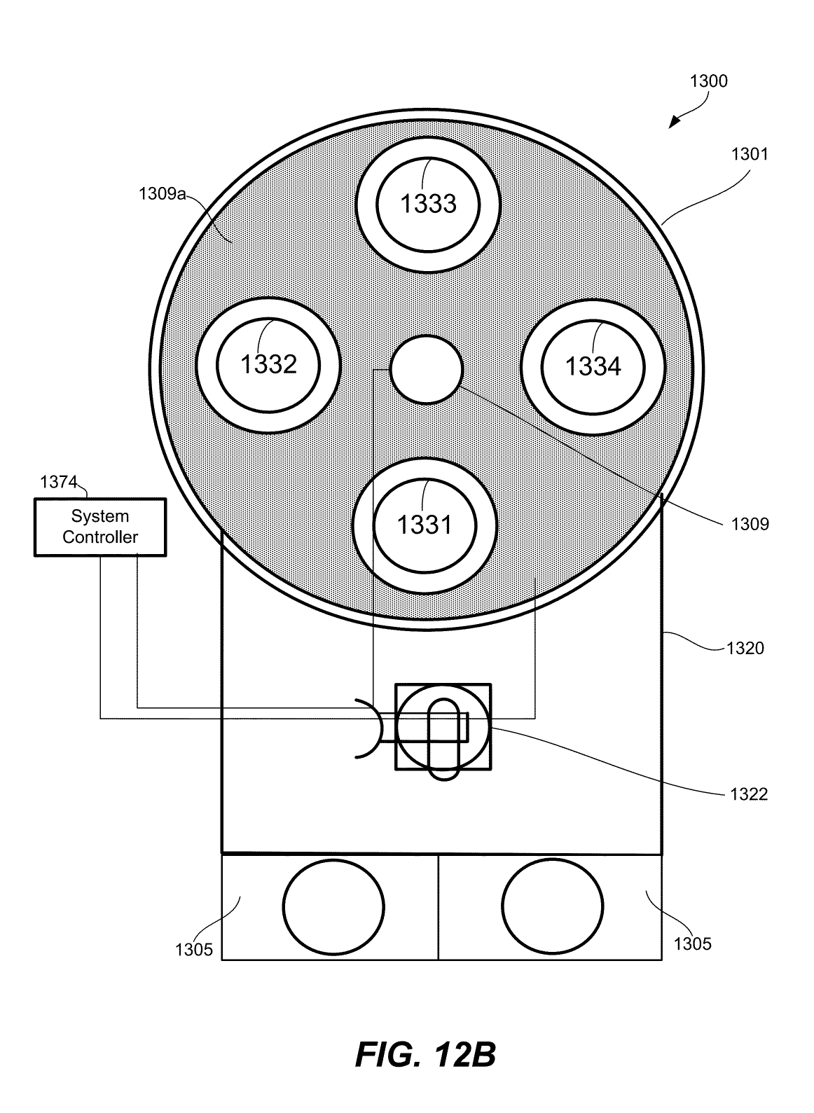

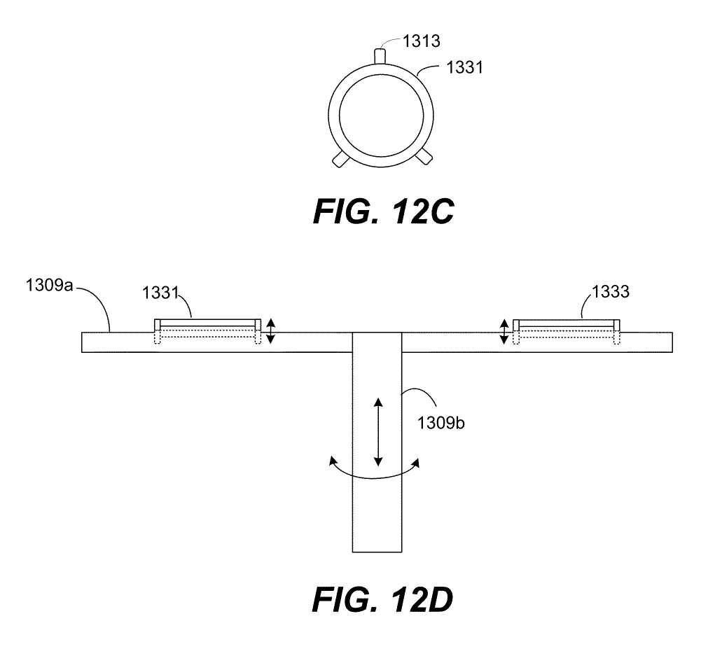

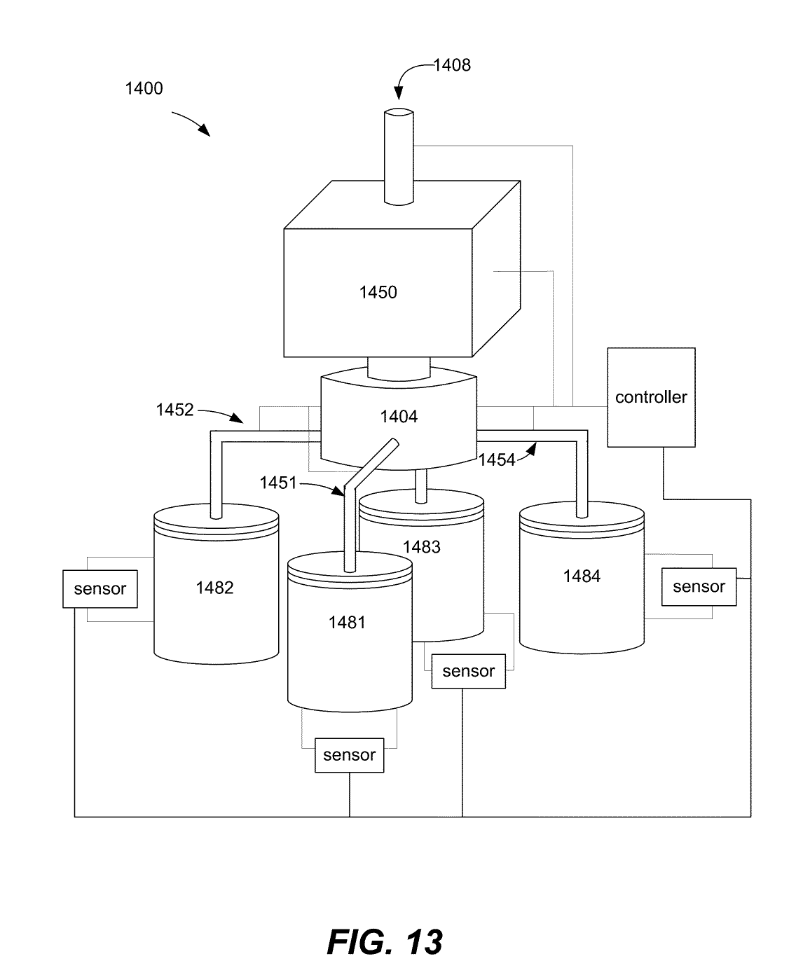

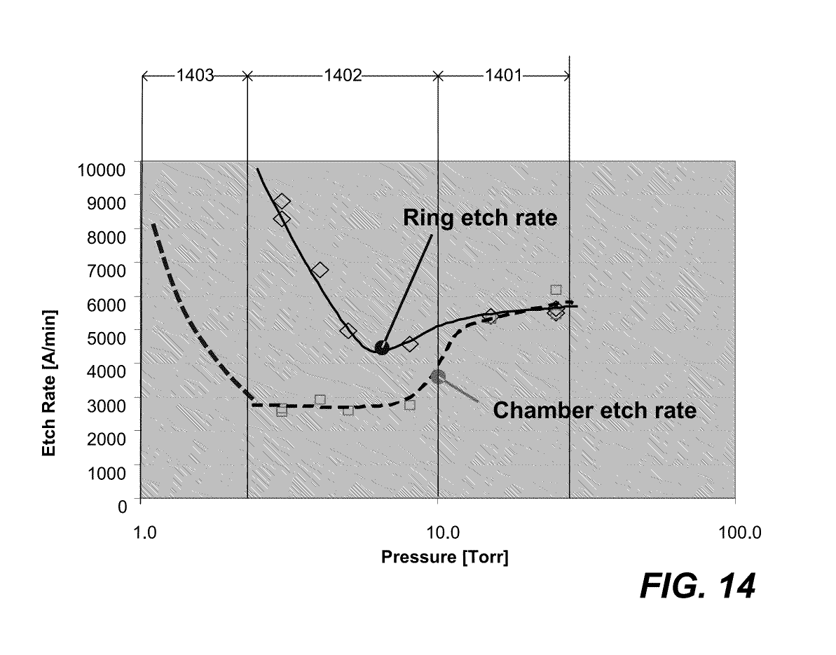

As shown in FIG. 8, inert gas can be introduced to the stations at points 851, 852, 854, and a point on the inlet to showerhead 823 (not shown). As shown, inert gas is introduced downstream of the remote plasma generator 850 and upstream of the showerheads 821, 822, 823, and 824. The amount of inert gas flow in each station can range from 0 to 1500 sccm. In various embodiments, the amount of inert gas flow total in all of the stations ranges from 0 sccm to 10000 sccm, e.g., 5000 sccm.

In some embodiments, inert gas can be introduced strategically at various points in the chamber to facilitate a more efficient cleaning mechanism or to shorten cleaning time. In certain embodiments, strategically introducing inert gas at various points includes introducing inert gas such that the flow of fluorine from the remote plasma source is redirected to the station with the highest accumulation of film or tungsten. In certain embodiments, strategically introducing inert gas at various points includes introducing inert gas such that the flow of fluorine from the remote plasma source is directed at the station with the highest substrate support temperature.

In various embodiments, a smaller amount of inert gas is introduced to the inlet corresponding to the station with a higher substrate support temperature. In some embodiments, the inert gas is introduced such that fluorine from the fluorine distribution module 904 is redirected to stations with a higher substrate support temperature. For example, if the station corresponding to showerhead 824 had a higher substrate support temperature than the station corresponding to showerhead 821, then the amount of inert gas introduced at 854 is less than the amount of inert gas introduced at 851. Then, when fluorine flows from 904, as discussed below, more fluorine will enter the station corresponding to showerhead 824 than the station corresponding to showerhead 821.

In some embodiments, a threshold amount of inert gas is introduced to an inlet such that the corresponding station has an increased cleaning rate. In some embodiments, inert gas can be flowed directly to an entire multi-station chamber, distinct from the individual inlets to each station.

Referring back to FIG. 6, in operation 608, fluorine is introduced to stations of the deposition chamber. As shown in FIG. 8, fluorine is introduced by flowing a fluorine-containing compound, e.g., NF₃, through 908 to the remote plasma generator 850, which generates fluorine etchant species that flow to fluorine distribution module 904. In some embodiments, atomic fluorine is generated from the remote plasma generator 850. From there, fluorine is distributed to each of the stations through the inlets 851, 852, 854, and the inlet to showerhead 823 as shown in the figure. As a result of the inert gas introduced, fluorine may be redirected to other stations depending on the amount of inert gas present in the inlets.

In some embodiments, the flow rate of fluorine in this operation may be at least about 3750 sccm, or at least about 4000 sccm, or at least about 6500 sccm. In some embodiments, the flow rate of fluorine is about 6500 sccm. In some embodiments, the cleaning time during the first stage is greater than the cleaning time in the second stage discussed below. In some embodiments, the cleaning time is at least about 3 minutes, or at least about 10 minutes, or at least about 15 minutes. In various embodiments, the cleaning time depends on the accumulation of film in the station or the substrate support temperature in the station. For example, the first stage can range be about 15 minutes for 25 micron accumulation.

With reference to FIG. 6, in operation 610, tungsten is removed from the carrier ring and other areas of the station. In some embodiments, tungsten is removed from the carrier ring and the inner diameter of the carrier ring. This completes the first stage at high pressure.

In operation 612, the pressure is lowered in the chamber to initiate the second stage at low pressure. In some embodiments, the pressure of the chamber is less than or equal to about 8 Ton. In various embodiments, the pressure of the chamber is below or equal to about 5 Torr, and in certain embodiments, below or equal to about 3 Torr. In some embodiments, the pressure of the chamber is about 1 Torr.

Next, in operation 614, carrier rings are indexed. For example, the carrier rings are indexed twice. Indexing can be performed by any indexing method and any indexing tool, including rotating a spindle that moves carrier rings between stations. All variations of indexing with reference to operation 604 can be applied to operation 614.

Next, in operation 616, the carrier ring in each station is lifted from the substrate support and towards the showerhead. The mechanism for lifting the carrier ring is further described below with reference to FIG. 12. FIG. 9 shows one embodiment of the carrier ring 833 lifted in a station 800 during the second stage at a low pressure after the carrier rings were indexed such that carrier ring 831 was moved to a different station and carrier ring 833 was moved into the station 800 shown in FIG. 9. The carrier ring 833 during this operation has already been cleaned as shown in the figure. It should be noted the location and thickness of the tungsten film remaining after the first stage may vary.

Referring back to FIG. 6, in operation 618, a fluorine-containing compound, e.g., NF₃, is flowed into the remote plasma generator at a higher flow rate than that during the first stage such that a greater amount of fluorine is introduced to each station as compared to operation 608. In some embodiments, the flow rate of fluorine in this operation is at least about 8000 sccm.

During this operation, the fluorine may exothermically react with tungsten at the substrate support 804. The greater amount of fluorine allows for more aggressive clean in the low pressure operation after the carrier ring 831 is cleaned, with little harm to the carrier ring 831. This is because the carrier ring 831 is in a lifted position away from the substrate support during the operation, which cools the carrier ring 831, and protects it. The fluorine flowing in from the showerhead 821 is not reacting near the showerhead 821 because the carrier ring 831 is clean and does not have tungsten on it. Because no exothermic cleaning reactions occur on the carrier ring 831, the second stage may be more aggressive than the first stage without damage to the carrier ring. Greater fluorine flows and/or lower pressure regimes can provide more aggressive cleans. This operation can take a shorter amount of time than operation 708.

In operation 620, the tungsten is removed and cleaned from the rest of the station. FIG. 11 shows a cleaned station 800 after operation 620, where there is no more tungsten on the station walls 806, underneath the substrate support 804, on the support 808 of the substrate support, on the substrate support 804, or on the carrier ring 833.

In some embodiments, the total cleaning time of operations 602 through 620 in FIG. 7 depends on the amount of accumulation of film in the stations. In many embodiments, the total cleaning time depends on the substrate support temperature of each station. In various embodiments, the total cleaning time is at least about 4 minutes, or at least about 25 minutes, or at least about 28 minutes. The total cleaning time may depend on the amount of tungsten to clean and may range from about 3 minutes to 30 minutes for 25 micron accumulation.

Referring back to FIG. 8, as indicated above, in certain embodiments, NF₃ is introduced to the remote plasma generator 850. According to various embodiments, species that leave the remote plasma generator can include N³⁺, F⁻, NF²⁺, NF₂⁺, NF₃ and F₂. Argon (or other inert gas) can be introduced downstream of the remote plasma generator 850 (and downstream of where the plasma species split) and upstream of the showerheads, for example, at points 851, 852 and 853. In some embodiments, the argon gas can carry the ionic species to the carrier ring surface to clean the carrier ring slowly without peeling during a high pressure first stage. The remaining F₂ can reach the bottom of the chamber and clean during this stage. For example, xF⁻ may be present at the carrier ring with xF₂ present at the chamber bottom.

Apparatus

The methods presented herein may be carried out in various types of deposition apparatuses available from various vendors. Examples of a suitable apparatus include a Novellus Concept-1 ALTUS™, a Concept 2 ALTUS™, a Concept-2 ALTUS-S™, Concept 3 ALTUS™ deposition system, and ALTUS Max™ or any of a variety of other commercially available chemical vapor deposition (CVD) tools. Stations in both single station and multi-station deposition apparatuses can be cleaned by the methods described above.

FIG. 11 shows an apparatus 1260 that may be used in accordance with various methods previously described. The deposition station 1200 to be cleaned typically has a substrate support 1204 that supports a wafer during deposition. Carrier ring 1231, which is typically made of ceramic, can cover the edge of a wafer and is used to prevent deposition on the edge as an exclusion ring. The carrier ring 1231 can also be used to transport wafers from station to station as a carrier ring.

The methods of the disclosed embodiments involve introducing an inert gas to a station 1200 downstream of a remote plasma generator 1250 and upstream of a showerhead 1202 through the inlet 1251 as shown in the figure. FIG. 12 shows just one example of a remote plasma generator 1250 connected to a station 1200; other arrangements and configurations may be used.

To determine the amount of inert gas to introduce to a station relative to another station, sensors such as 1276 may be used to provide information to the controller 1274.

Gas sensors, pressure sensors, temperature sensors, etc. may be used to provide information on station conditions during various embodiments. Examples of station sensors that may be monitored during the clean include mass flow controllers, pressure sensors such as manometers, thermocouples located in pedestal, and infra-red detectors to monitor the presence of a gas or gases in the station. Sensors may be used to provide information to determine the flow rate of a fluorine-containing compound, e.g., nitrogen trifluoride (NF₃), to the remote plasma generator 1250.

During the operations where fluorine is introduced, fluorine enters the station and etches the tungsten film (not shown) deposited on the station components as discussed above. One of ordinary skill in the art will understand that other species may be present in the plasma or gases exiting the showerhead into the station. For example, during a low pressure stage, the species entering the deposition chamber from the showerhead typically include NF₃ as well as F₂.

In some embodiments, fluorine is supplied to the station by using a remote plasma source, such as the remote plasma generator 1250. One example of a remote plasma generator suitable for the disclosed methods is the Astron.

Fluorine may be supplied to the station by methods other than using a remote plasma source or remote plasma generator to generate fluorine. For example, fluorine gas may be introduced into the chamber from a fluorine gas supply. However, the remote plasma generator allows the use of NF₃, which is easier to handle than fluorine as an inlet gas to the system. Certain embodiments may employ a direct (in situ) plasma for the generation of fluorine, rather than a remote plasma source, such as in embodiments where indexing is used without modulating inert gas flow.

As the tungsten is removed from the station, tungsten hexafluoride may be produced. The tungsten hexafluoride may be sensed by sensors such as 1276, providing an indication of the progress of the clean. The tungsten hexafluoride is removed from the station via an outlet such that once the clean is complete, the sensor will detect no tungsten hexafluoride. A window 1272 may be used to provide visual inspection of the carrier ring 1231. The window 1272 may also be located on the top of the station 1200.

In certain embodiments, a controller 1274 is employed to control process conditions of the station during the clean. Details on types of controllers are further discussed below with reference to FIGS. 12 and 13 and the discussions with respect to these figures are applicable to the controller for the station as well as for the chamber.

FIGS. 12A and 12B show examples of multi-station apparatus that may be used with certain embodiments. The apparatus 1300 includes a processing chamber 1301, which houses a number of stations. The processing chamber can house at least two stations, or at least three stations, or at least four stations or more. FIGS. 12A and 12B each show an apparatus 1300 with four stations.

All stations in the multi-station apparatus 1300 with a processing chamber 1301 may be exposed to the same pressure environment controlled by the system controller 1374. Sensors (not shown) may also include a pressure sensor to provide chamber pressure readings. However, each station may have individual temperature conditions or other conditions.

The four stations correspond to four carrier rings 1331, 1332, 1333, and 1334, which can also be connected to an indexing tool 1309 as shown in the figures. In some embodiments, the indexing tool includes a spindle, and operation of the indexing tool involves rotating the spindle to move carrier rings between stations.

As depicted in FIG. 12A, the indexing tool 1309 may include a fin with at least one arm for each station such that each arm extends toward one station. At the end of the arm adjacent to the stations are four fingers that extend from the arm with two fingers on each side. These fingers can be used to lift, lower, and position a carrier ring, such as 1331, or a carrier ring carrying a wafer within each station.

For example, in some embodiments where the multi-station apparatus includes four stations such as the one shown in FIG. 12A, the indexing tool is a four-arm rotational assembly, or spindle, with four arms on one fin. As shown in FIG. 12A, the fin of the spindle assembly includes four arms, with each arm having four fingers.

A set of four fingers, i.e., two fingers on a first arm and two fingers on an adjacent, second arm, are used to lift, position, and lower a wafer or carrier ring from one station to another station. For example, fingers are used to lift, position, and lower carrier ring 1331 from its station to another station in accordance with various embodiments.

In transferring a carrier ring, such as carrier ring 1331, from one station to another, the indexing tool 1309 moves the arms of the fin in an upward direction within the processing chamber 1301, thereby lifting the carrier ring 1331 in an upward direction away from the substrate support in the station corresponding to carrier ring 1331 using the four fingers residing under carrier ring. The spindle then moves the carrier ring 1331 from the station corresponding to carrier ring 1331 to, for example, the station corresponding to carrier ring 1332. The spindle can also move the carrier rings in a counter-clockwise direction. Indexing operations can be performed in this manner or any similar manner known to one skilled in the art.

FIG. 12B shows another example of apparatus 1300 including an indexing tool 1309. In the example of FIG. 12B, indexing tool 1309 has circular locations where the wafer carrier rings 1331, 1332, 1333, and 1334 fit in to rotate among stations. The indexing tool 1309 includes a spindle as well as a plate 1309a on which the carrier rings 1331, 1332, 1333, and 1334 rest. In transferring a carrier ring from one station to another, the indexing tool, including the plate 1309a, rotates. FIG. 12C shows examples of a carrier ring 1331 that may be employed with the apparatus shown in FIG. 12B. The carrier ring 1331 includes tabs 1313 that allow it fit with the plate 1309a. FIG. 12D shows an example of carrier rings 1331 and 1333 on a plate 1309a. Carrier rings 1331 and 1333 are configured to vertically relative to the plate 1309 as indicated in the figure. The spindle 1309b can move vertically and rotate.

Returning to FIGS. 12A and 12B, in a deposition process, typically a wafer to be processed through a load-lock 1305 into the station corresponding to carrier ring 1331. In the example of FIG. 12A, the wafer is loaded from one of the cassettes 1303 to the load-lock 1305. An external robot 1307 may be used to transfer the wafer from the cassette 1303 into the load-lock 1305. In the depicted embodiment, there are two separate load-locks 1305. These are typically equipped with wafer transferring devices to move wafer from the load-lock 1305 into the station corresponding to carrier ring 1331 and from the station corresponding to carrier ring 1334 back into the load-lock 1305 for removal from the processing chamber 1301. An internal robot (not shown) is used to transfer wafers among the stations and support some of the wafers during the process. Before beginning certain methods of the disclosed embodiments, wafers are removed from stations by moving wafers from a station to the load-lock 1305 and to the cassette 1303 out of the processing chamber 1301. For example, according to some of the methods described in the disclosed embodiments, wafers are removed by moving wafers from the stations into load-lock 1305 and back to cassette 1303.

The wafers may also enter and exit the processing chamber 1301 directly from or to a vacuum transfer chamber 1320 as depicted in FIG. 12B. A vacuum transfer robot 1322 can transfer the wafers from load-locks 1305 to the processing chamber 1301. The wafers may be transferred between the load-locks 1305 and storage cassettes by another robot (not shown).

A system controller 1374 can control conditions of the indexing tool 1309, the stations, and the processing chamber 1301, such as the pressure of the chamber. For example, the controller 1374 may control the position of the carrier rings 1331, 1332, 1333, 1334 within each station (lifted up, or down on the substrate support) or the moving of the carrier rings 1331, 1332, 1333, 1334 between stations. Types of controllers and controller parts are further discussed below with reference to FIG. 13.

FIG. 13 shows a side-view of a multi-station apparatus 1400 with four stations 1481, 1482, 1483, and 1484. Each station has a corresponding showerhead. According to certain embodiments, a fluorine-containing compound, e.g., NF₃, is flowed in at 1408 into the remote plasma generator 1450, where fluorine is processed to the fluorine distribution module 1404. There, fluorine is distributed to each showerhead connected to the four stations via the inlets for each station as shown in the figure. In some embodiments, an inert gas is introduced into the inlets at 1451, 1452, 1454, and a point on the inlet (not shown) connecting to the showerhead of station 1483. Inert gas can also be introduced to the entire chamber via other inlets (not shown) that are not individually directed to a point upstream of each station's showerhead and downstream of the remote plasma generator 1450.

A controller controls conditions of the chamber 1400, such as the flow rate of NF₃ and the flow rate of inert gas at 1451, 1452, and 1454. Sensors may be used to provide information to the controller to determine the amount of fluorine or inert gas or other compound to flow into the chamber or inlet. Sensors may also include a pressure sensor to provide chamber pressure readings. These sensors may also provide information on station conditions during the clean and can operate like the sensor 1276 referenced above with respect to FIG. 11. Examples include thermocouples located in the substrate support, pressure sensors such as manometers, and others. The tungsten hexafluoride produced during cleaning may be sensed by sensors such as the ones connected to each station as shown in the figure which provides an indication of the progress of the clean. The tungsten hexafluoride is removed from the station via an outlet such that once all or almost all of the tungsten film is removed, the sensor will sense no tungsten hexafluoride.

A controller, such as those depicted in FIGS. 11, 12, and 13, typically includes one or more memory devices and one or more processors. The processor may include a CPU or computer, analog, and/or digital input/output connects, stepper motor controller boards, etc.

The controller, such as those depicted in FIGS. 11, 12, and 13 executes system control software, including sets of instructions for controlling the timing of the cleaning operations, positioning of the carrier rings, determining the temperatures of the stations, controlling the pressure of the chamber, introducing certain amounts of fluorine to the chamber, introducing certain amounts of inert gas to the stations, and monitoring other process parameters. Other computer programs stored on memory devices associated with the controller may be employed in some embodiments.

In certain embodiments, there will be a user interface associated with controller 1374. The user interface may include a display screen, graphical software displays of the apparatus and/or cleaning conditions, and user input devices such as pointing devices, keyboards, touch screens, microphones, etc.

The computer program code for controlling the processing operations can be written in any conventional computer readable programming language: for example, assembly language, C, C++, Pascal, Fortran, or others. Compiled object code or script is executed by the processor to perform the tasks identified in the program. Code may be provided on machine readable instructions or hard coded.

The controller parameters relate to cleaning conditions such as, for example, timing of the cleaning operations, flow rates, pressure of the chamber and other parameters of a particular cleaning process. These parameters are provided to the user in the form of a recipe, and may be entered utilizing a user interface.

The system software may be designed or configured in many different ways. For example, various chamber component subroutines or control objects may be written to control operation of the chamber components necessary to carry out the cleaning processes. Examples of programs or sections of programs for this purpose include timing of the cleaning process code, flow rates, and temperatures of the stations code, and a code for pressure of the chamber.

The system controller 1374 of FIG. 13 may receive input from the user interface (e.g., an operator entering process parameters, such as temperature requirements, duration of various cleaning operations) and/or various sensors (e.g., thermocouples measuring substrate support temperatures, radiation measuring devices, sensors registering positions of carrier rings, sensors measuring amount of tungsten hexafluoride, pressure measuring devices, and others). The system controller 1374 may be connected to actuator mechanisms of each station inside the processing chamber 1301 and configured to control positions (e.g., raised, lowered, intermediate, variable, or any other position) of each carrier ring 1331, 1332, 1333, and 1334 based on the input provided to the system controller 1374. The system controller 1374 may verify certain process conditions from one or more sensors, e.g., a temperature of a substrate support. The system controller 1374 may determine that based on all available input the carrier rings 1331, 1332, 1333, and 1334 should be in a lifted position and verify the current position of the carrier rings. The system controller 1374 may then instruct the indexing tool 1309 of the station to move the carrier rings into the lifted position. Further, receiving input and adjusting carrier rings' positions may be a dynamic process. The system controller 1374 may continuously receive input (e.g., tungsten hexafluoride amount in each station) and adjust flow rate of NF₃ to the chamber.

In general, one advantage of the disclosed embodiments is that it balances temperature in each station to facilitate shorter cleaning time and a more uniform clean. By one or more of modulating inert gas flow downstream of a remote plasma source, adjusting chamber pressure, lifting the carrier ring when it is clean for additional cleaning stages, and adjusting the amount of the fluorine etchant species provided to the stations, the apparatus can accommodate various different conditions during the cleaning process to provide an efficient and fast cleaning process to increase throughput.

The apparatus/process described hereinabove may be used in conjunction with lithographic patterning tools or processes, for example, for the fabrication or manufacture of semiconductor devices, displays, LEDs, photovoltaic panels and the like. Typically, though not necessarily, such tools/processes will be used or conducted together in a common fabrication facility. Lithographic patterning of a film typically comprises some or all of the following steps, each step enabled with a number of possible tools: (1) application of photoresist on a workpiece, i.e., substrate, using a spin-on or spray-on tool; (2) curing of photoresist using a hot plate or furnace or UV curing tool; (3) exposing the photoresist to visible or UV or x-ray light with a tool such as a wafer stepper; (4) developing the resist so as to selectively remove resist and thereby pattern it using a tool such as a wet bench; (5) transferring the resist pattern into an underlying film or workpiece by using a dry or plasma-assisted etching tool; and (6) removing the resist using a tool such as an RF or microwave plasma resist stripper.

### EXPERIMENTAL

Tungsten film was removed from stations of a multi-station chamber with four stations using a process A where carrier rings were not indexed. Tungsten film was also removed from stations of a multi-station chamber with four stations using a process B in which carrier rings were indexed.

In process A, tungsten film was removed from a four-station multi-station chamber suitable for chemical vapor deposition (CVD) processes. Two stations were used for pulsed nucleation layer (PNL) deposition processes, labeled Station 1 and Station 2. Two stations were used for CVD processes, labeled Station 3 and Station 4. Conditions of the experiment and temperature of each station are listed below in Table 1. Processed wafers were removed from the stations. In the first step, carrier rings were not indexed. Carrier rings were on the substrate support. The pressure of the chamber was 10 Torr. The flow rates of argon as an inert gas into each individual station were all 2000 sccm. Argon was flowed at 2000 sccm to isolate stations from each other. The stations were cleaned by flowing NF₃ at a flow rate of 6500 sccm to a remote plasma generator, which ultimately introduced fluorine into each station.

In the second step, carrier rings were lifted from the substrate support in each station. Carrier rings were not indexed. The pressure of the chamber was lowered to 3 Torr. The flow rates of argon to each of the PNL stations were kept the same, and the flow rates of argon to each of the CVD stations were decreased to 1000 sccm of argon. The flow rate of argon to isolate stations was increased to 4000 sccm. The stations were cleaned by flowing 8000 sccm of NF₃ to the remote plasma generator.

In process B, the types of stations for each of the four stations were the same as the types in process A. Temperature conditions were also the same as those in process A. After processed wafers were removed, carrier rings were indexed twice such that carrier rings moved two stations over from the original station. That is, the carrier ring from Station 1 moved to Station 3, the carrier ring from Station 2 moved to Station 4, the carrier ring form Station 3 moved to Station 1, and the carrier ring form Station 4 moved to Station 2. Carrier rings were maintained in the down position on the substrate support of the station the carrier rings moved to. The pressure of the chamber was 10 Torr. Argon was flowed individually to each station. No isolation argon was flowed. The flow rates of argon as an inert gas to each of the stations were 1500 sccm to each station. The stations were cleaned by flowing NF₃ at a flow rate of 6500 sccm to a remote plasma generator, which flowed fluorine into each station. The flow rate of NF₃ was the same flow rate as in step 1 of process A.

In the second step, carrier rings were again indexed twice such that carrier rings moved back to their original stations. The pressure of the chamber was lowered to 1 Torr. No argon was flowed to any of the stations or the entire chamber. The stations were cleaned by flowing 8000 sccm of NF₃ to the remote plasma generator.

Processes A and B were conducted for stations with an accumulation of tungsten of 25 lam of tungsten and for stations with an accumulation of tungsten of 30 μm of tungsten. Table 1 summarizes the conditions used and results obtained in processes A and B.

TABLE 1
Processes A and B Conditions and Results

| | Process A | | | | Process B | | | |
|---|---|---|---|---|---|---|---|---|
| Conditions | Step 1 | | Step 2 | | Step 1 | | Step 2 | |
| Indexing | None | | None | | Twice | | Twice | |
| Carrier Ring Position | Down | | Up | | Down | | Up | |
| Chamber Pressure | 10 | Torr | 3 | Torr | 10 | Torr | 1 | Torr |
| Isolation Curtain Ar Flow Rate to | 2000 | sccm | 4000 | sccm | 0 | sccm | 0 | sccm |
| between each station | | | | | | | | |
| Total Ar Flow Rate for PNL Stations 1 | 4000 | sccm | 4000 | sccm | 3000 | sccm | 0 | sccm |
| and 2 | | | | | | | | |
| Total Ar Flow Rate for CVD Stations 3 | 4000 | sccm | 2000 | sccm | 3000 | sccm | 0 | sccm |
| and 4 | | | | | | | | |
| Temperature of PNL Stations 1 and 2 | 300° C. | | | | 300° C. | | | |
| Temperature of CVD Stations 3 and 4 | 400° C. | | | | 400° C. | | | |
| NF₃ Flow Rate | 6500 | sccm | 8000 | sccm | 6500 | sccm | 8000 | sccm |

| Accumulation of Tungsten (μm) | Cleaning Time* (seconds) | Cleaning Time* (seconds) |
|---|---|---|
| 25 | 1993 | 1513 (24% faster) |
| 30 | 2236 | 1742 (22% faster) |

*Including 10% over-etch

The total Ar flows for PNL stations 1 and 2 is split equally between the stations, such that PNL station 1 receives 2000 sccm for process A step 1, etc. The same applies to the total Ar flows for CVD stations 3 and 4.

As shown in the table, process B including the indexing operations during the process was over 20% faster than process B for both tungsten accumulation trials. Indexing carrier rings helped remove tungsten film from the stations at a faster rate, which facilitates higher throughput and improved efficiency of fabrication processes.

FIG. 14 shows etch rate of a chamber and a carrier ring in the station as a function of chamber pressure. Three clean regimes that may correspond to cleaning stages are shown: 1401, 1402 and 1403. At 1401, a ring clean regime for with a medium ring etch rate and small ring to chamber clean difference is shown. In certain embodiments, a ring is cleaned first in this regime. At 1402, a regime in which the ring etch rate increases and the chamber etch decreases is shown. At 1403, a low pressure regime that achieves a higher etch rate is shown. At 1401, a low pressure, high throughput regime is shown. In some embodiments, a clean involves a first stage in regime 1401 followed by a second stage in regime 1403. The endpoints of each of the pressure ranges of the regimes may vary according to the particular process and apparatus.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems and apparatus of the present embodiments. Accordingly, the present embodiments are to be considered as illustrative and not restrictive, and the embodiments are not to be limited to the details given herein.

What is claimed is:

1. A method of removing film deposited on surfaces in stations of a multi-station deposition chamber, each station of the multi-station deposition chamber comprising a showerhead and a substrate support, the method comprising:
introducing a first amount of an inert gas to a first station and a second amount of the inert gas to a second station; and
introducing a first amount of fluorine from a remote plasma source to the stations in the multi-station deposition chamber via the showerheads;
wherein
the inert gas is introduced upstream of each showerhead and downstream of the remote plasma source,
the first amount of the inert gas is more than the second amount of the inert gas, and
a substrate support temperature in the first station is higher than a substrate support temperature in the second station.

2. The method in claim 1, wherein the film is a tungsten-containing film.

3. The method in claim 1, wherein the inert gas is argon.

4. The method in claim 1, wherein the multi-station deposition chamber comprises four stations.

5. The method in claim 4, further comprising introducing a third amount of the inert gas to a third station and a fourth amount of the inert gas to a fourth station,
wherein the amount of the inert gas introduced to a station with a higher substrate support temperature is lower than the amount of the inert gas introduced to a station with a lower substrate support temperature.

6. The method in claim 1, wherein the total amount of inert gas introduced to a station is not more than about 5000 sccm.

7. The method in claim 1, wherein the total amount of deposited film in the first station is greater than the total amount of deposited film in the second station.

8. The method in claim 1, wherein the fluorine introduced is generated as atomic fluorine in the remote plasma source.

9. The method in claim 8, wherein generating the atomic fluorine in the remote plasma source comprises flowing nitrogen trifluoride (NF₃) into the remote plasma source.

10. The method in claim 1, further comprising:
lifting a carrier ring in each station; and
introducing a second amount of fluorine from the remote plasma source to the stations via each of the showerheads,
wherein the second amount of fluorine is greater than the first amount of fluorine.

11. The method in claim 10, wherein the pressure of the multi-station deposition chamber while introducing the first and second amounts of the inert gas and the first amount of fluorine is higher than the pressure of the multi-station deposition chamber while introducing the second amount of fluorine.

12. A method of removing film deposited on surfaces in stations of a multi-station deposition chamber, each station of the multi-station deposition chamber comprising a showerhead and a substrate support, the method comprising:
a first stage at a first pressure comprising:
introducing a first amount of an inert gas to a first station; and
introducing a first amount of fluorine from the remote plasma source to the first station of the multi-station deposition chamber; and
a second stage at a second pressure comprising:
introducing a second amount of fluorine from the remote plasma source to the first station of the multi-station deposition chamber,
wherein the inert gas is introduced upstream of the showerhead of the first station and downstream of the remote plasma source, the first pressure is greater than the second pressure.

13. The method in claim 12, wherein the film is a tungsten-containing film.

14. The method in claim 12, wherein the inert gas is argon.

15. The method in claim 12, wherein the first pressure is about 10 Torr.

16. The method in claim 12, wherein the second pressure is about 1 Torr.

17. The method of claim 12, wherein the first stage at the first pressure further comprises introducing a second amount of the inert gas to a second station,
wherein the inert gas is introduced upstream of the showerhead of the second station and downstream of the remote plasma source,
the first amount of the inert gas is greater than the second amount of the inert gas, and
a substrate support temperature in the first station is greater than a substrate support in the second station.

18. The method of claim 12, wherein the second amount of fluorine is greater than the first amount of fluorine.

19. The method of claim 18, wherein each station comprises a carrier ring and in each station, the carrier ring is on the substrate support during the first stage and lifted from the substrate support during the second stage.

20. The method of claim 18, wherein
the first stage further comprises:
prior to introducing the first amount of the inert gas to the first station, indexing the carrier rings between stations in the multi-station deposition chamber; and
the second stage further comprises:
prior to introducing the second amount of fluorine, indexing the carrier rings between stations in the multi-station deposition chamber.

21. The method in claim 12, wherein the fluorine introduced to the multi-station deposition chamber is generated as atomic fluorine in a remote plasma source and introduced to the stations in the multi-station deposition chamber via showerheads.

22. The method in claim 21, wherein generating the atomic fluorine in a remote plasma source comprises flowing nitrogen trifluoride (NF₃) into the remote plasma source.

23. A method of removing film deposited on surfaces in stations of a multi-station deposition chamber, each station of the multi-station deposition chamber comprising a carrier ring, a showerhead and a substrate support, the method comprising:
prior to introducing fluorine to the multi-station deposition chamber, indexing carrier rings between stations in the multi-station deposition chamber,
wherein the carrier ring moves from a first station to a second station.

24. The method in claim 23, wherein indexing comprises rotating a spindle configured to move carrier rings between stations in the multi-station deposition chamber.

25. The method in claim 23, further comprising indexing at least two carrier rings and moving each carrier ring from one station to an adjacent station.

26. The method in claim 25, further comprising indexing the carrier rings twice prior to introducing fluorine to the multi-station deposition chamber.

27. An apparatus configured to remove film deposited on surfaces after a deposition process, the apparatus comprising:
(a) a multi-station chamber comprising:
two or more stations;
a remote plasma source;
at least one indexing tool configured to move carrier rings between stations in the apparatus,
wherein a station comprises a showerhead, a substrate support, and one or more gas inlets;
(b) a controller for controlling the operations in the apparatus, comprising machine readable instructions for:
executing a first stage at a first pressure, the first stage comprising:
introducing a first amount of an inert gas to a first station,
wherein the inert gas is introduced upstream of the showerhead of the first station and downstream of the remote plasma source, and
introducing a first amount of fluorine from a remote plasma source to the first station of the multi-station chamber, and
executing a second stage at a second pressure less than the first pressure, the second stage comprising:
introducing a second amount of fluorine greater than the first amount of fluorine to the multi-station chamber.

28. The apparatus of claim 27, wherein the first stage further comprises:
introducing a second amount of an inert gas to a second station,
wherein the inert gas is introduced upstream of the showerhead of the second station and downstream of the remote plasma source, and
the first amount of the inert gas is greater than the second amount of the inert gas when a substrate support temperature in the first station is greater than a substrate support in the second station.

29. The apparatus of claim 27, wherein each station in the multi-station chamber further comprises a carrier ring and the controller further comprises machine readable instructions for lifting the carrier ring from the substrate support prior to executing the second stage.

30. The apparatus of claim 29, wherein the controller further comprises machine readable instructions for:
prior to introducing the first amount of the inert gas in the first stage, indexing carrier rings between stations in the multi-station chamber; and
prior to introducing the second amount of fluorine in the second stage, indexing carrier rings between stations in the multi-station chamber.
